(19) United States
(12) Patent Application Publication
(10) Pub. No.: US 2003/0128668 A1
(43) Pub. Date: Jul. 10, 2003

(54) Distributed implementation of control protocols in routers and switches

(76) Inventors: Rajendra S. Yavatkar, Portland, OR (US); Sanjay Bakshi, Beaverton, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/039,279

(22) Filed: Jan. 4, 2002

(51) Int. Cl. H04L 12/26

(52) U.S. Cl. 370/238; 370/252; 370/254

(57) ABSTRACT

A router uses a distributed implementation of a routing control protocol to route a packet between a plurality of computer networks. The router includes a control-plane having a control-plane processor to implement a central control portion of the control protocol and a plurality of forwarding-planes, each having a forwarding-plane processor, to implement an offload control portion of the control protocol. A back-plane connects the forwarding-planes to each other and to the control-plane. Together, these components route a packet based on the distributed implementation of the control protocol.

### TECHNICAL FIELD

This invention relates generally to routers and switches, and more particularly, to achieving a scalable and distributed implementation of a control protocol.

### BACKGROUND

Routers and switches, hereinafter refer to collectively as routers, route (that is, direct and control) the flow of data packets between computers. Routers direct and control the flow of packets based on various control protocols, such as Open Shortest Path First protocol (“OSPF”), Routing Information Protocol (“RIP”), Label Distribution Protocol (“LDP”), and Resource reSerVation Protocol (“RSVP”).

Typically, a router control protocol is responsible for generating routing tables, exchanging routing updates, establishing packet flow, determining multi-protocol label switching, and performing other routing control functions. Together, these control functions enable the router to direct and control the flow of packets between computers.

Routers also perform packet forwarding and processing functions. Packet forwarding and processing functions are distinct from control protocol functions. Packet forwarding and processing functions operate to process and prepare packets containing information to be sent between computers. Control functions, on the other hand, operate to direct and control the flow of these packets based on particular control protocols.

### DESCRIPTION OF DRAWINGS

FIG. 1 is a diagram of a network.

FIG. 2 is a block diagram of a router implementing a distributed control protocol.

FIG. 3 is a diagram depicting the flow of a control protocol for the distributed implementation of OSPF control protocol.

FIG. 4 is a flow diagram of a process for implementing the distributed.

FIG. 5 is a view of computer hardware used to implement the process of FIG. 4.

Like reference symbols in the various drawings indicate like elements.

### DETAILED DESCRIPTION

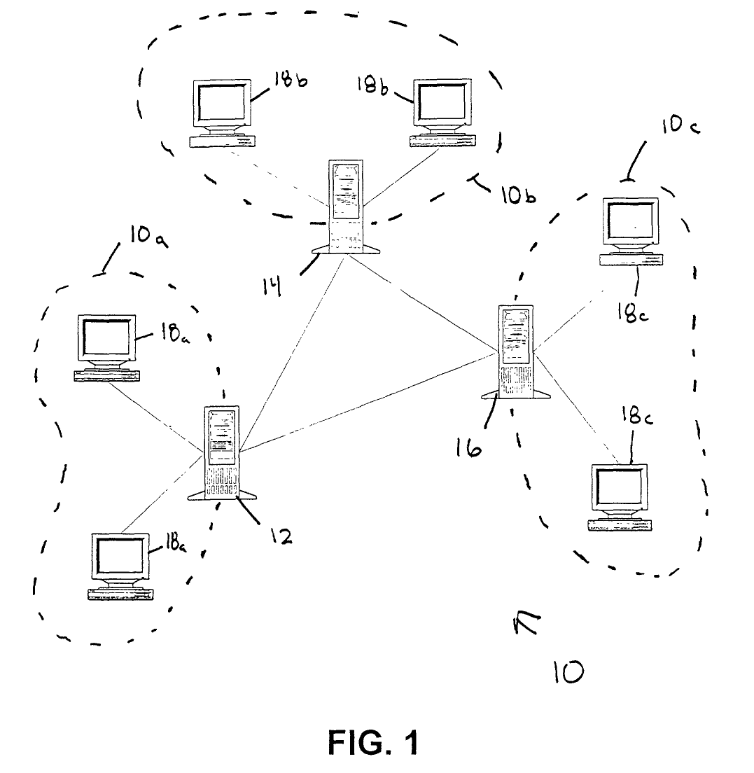

FIG. 1 shows a computer network 10 includes a plurality of computer networks 10a, 10b, and 10c connected to each other by routers 12, 14, and 16. Each computer network 10a, 10b, and 10c may have one or more computers 18a, 18b, and 18c.

Routers 12, 14, and 16 control and direct the flow of information in the form of packets (e.g., Internet Protocol packets) between computers in network 10. Routers 12, 14 and 16 control and direct the flow of each packet based on various control protocols, such as OSPF, RIP, LDP and RSVP.

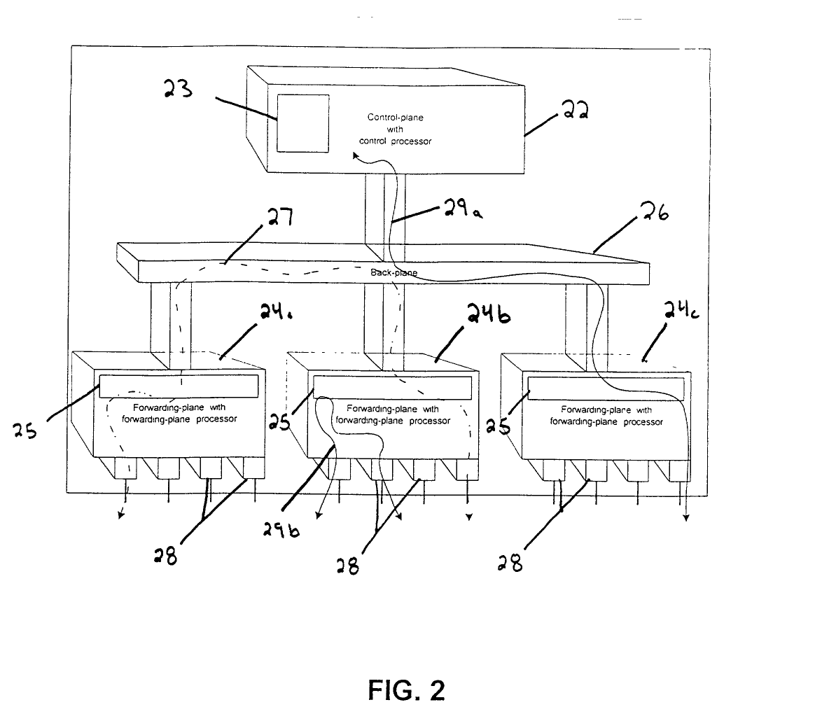

The following describe mechanism for distributing a control protocol for routers 12, 14 and 16 between control and forwarding planes. The control protocol is implemented by separating a control protocol into a central control portion implemented on a control-plane 22 (FIG. 2) and an off-load control portion implemented on a forwarding-plane 24. The present invention achieves a scalable, fault-tolerant implementation of a control protocol that may be scaled to handle hundreds of ports and/or interfaces. The present invention may also handle failure of central control plane software by allowing forwarding planes to continue to respond to control events and operate correctly during a recovery period. The embodiments described herein may be applied to all control protocols, e.g., control protocols, for implementing differentiated packet handling as necessary for quality of service, security, etc.

FIG. 2 shows the architecture of a router 20. Router 20 includes a control-plane 22 and one or more forwarding-planes 24. Control-plane 22 runs a control protocol and forwarding-planes 24 do packet processing.

In this regard, FIG. 2 shows a router 20 that implements a control protocol in a distributed manner. Router 20 has a control-plane 22, several forwarding-planes 24a, 24b and 24c, and a back-plane 26.

Control-plane 22 includes a control-plane processor 23, which may be a general purpose processor. Control-plane processor 23 operates to implement the central control portion of the distributed control protocol.

Forwarding-planes 24a, 24b and 24c include a forwarding-plane processor 25 and a plurality of ports 28. Forwarding-plane processor 25 likewise may be a network processor, or a micro controller, a programmable logic array or an application specific integrated circuit. Forwarding plane processor 25 implements the off-load portion of the distributed control protocol. Here, the central portion and the off-load portion of the distributed control protocol are separated, in part, based on which operations the control-plane processor 23 and the forwarding-plane processor 25 may efficiently perform and based on where the necessary state information is located.

Ports 28, here physical ports, connect router 20 to network 10. In other embodiments, ports 28 may comprise both virtual and physical ports in which one or more physical ports may represent a plurality of virtual ports connecting router 20 to network 10 using various control protocols.

Back-plane 26 connects forwarding-planes 24a, 24b and 24c to each other and to control-plane 22. For example, back-plane 26 allows a packet received from network 10a (FIG. 1) at a port 28 on forwarding plane 24a to be routed to network 10b connected to a port 28 on forwarding-plane 24b (e.g., see flow arrow 27). Back-plane 26 also allows central control protocol information to be sent between control-plane 22 and network 10c through forwarding-plane 10c (e.g., see flow arrow 29a).

In other examples, back-plane 26 may be used to send information based on off-load portions of the control protocol between forwarding-planes 24a and 24c without being forwarded to control-plane 22 (e.g., see flow arrow 27). In still other examples, back-plane 26 need not be used to send information based on off-load portions of the control protocol. Rather, that information may be received by, and sent from, the same forwarding plane (i.e., see control flow arrow 29b).

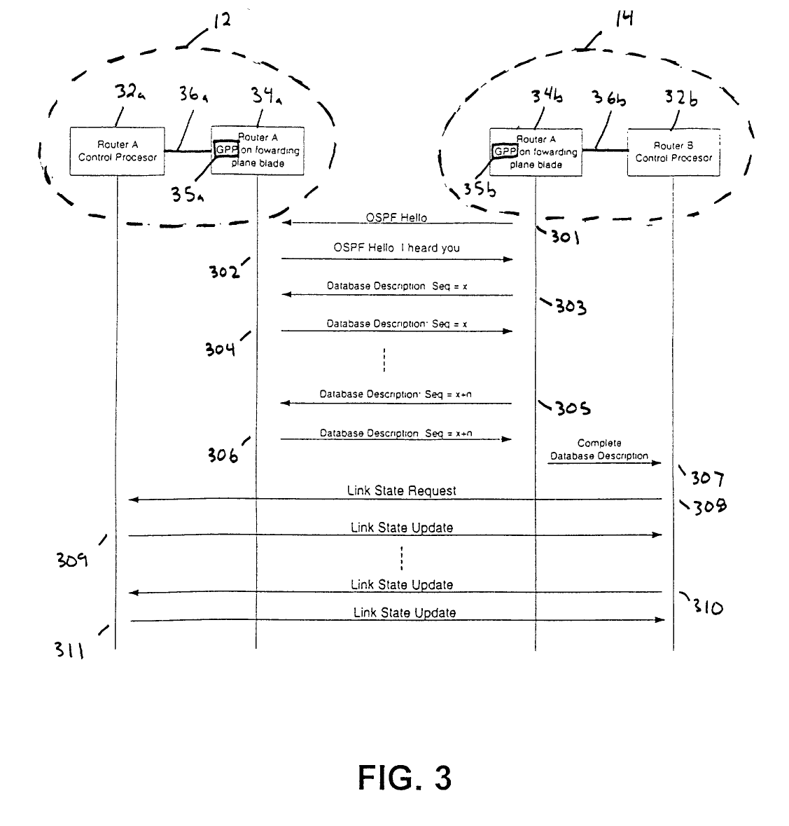

FIG. 3 shows routers 12 and 14 having control-planes 32a and 32b and forwarding-planes 34a and 34b for implementing a distributed control protocol (e.g., distributed OSPF). In this example, router 14 generates (301) an OSPF “HELLO” message at forwarding-plane 34b using an off-load portion of a distributed OSPF control protocol. Router 12, also using an off-load portion of the distributed OSPF control protocol, responds (302) to the HELLO message with an “I HEARD YOU” from forwarding-plane 34a. Router 14 now knows that router 12 is listening and requests (303) a “DATABASE DESCRIPTION” from router 12. Again, this request (303) is generated at forwarding-plane 34b using the off-loaded control portion of the distributed OSPF control protocol. Forwarding-plane 34a responds (304) using the off-load portion of the distributed OSPF control protocol with the appropriate “DATABASE DESCRIPTION” for router 12. This sequence of requests (303) and responses (304) continues until an n^{th} request (305) and response (306) for the DATABASE DESCRIPTION of router 12 has been received. Thereafter, the complete DATABASE DESCRIPTION for router 12 may be forwarded (307) from forwarding-plane 34b to control-plane 32b on back-plane 36b. Hence, the number of control flow transmissions between forwarding-plane 34a and control plane 32a over back-plane 36b is reduced (e.g., since the control information is transmitted only between forwarding-planes).

In this embodiment, it is the responsibility of control-planes 32a and 32b to keep the state in the offload portion current and correct. This implementation helps reduce processing on control-planes 32a and 32b, which becomes more significant as the number of ports and the number of control messages possessed by routers 12 and 14 increase.

At this point, control-processor 32b on router 14, using the central control portion of the distributed OSPF control protocol, requests (308) a LINK STATE REQUEST from router 12. In response, control processor 32a on router 12 also implementing the central control portion of the distributed OSPF control protocol responds (309) with a LINK STATE UPDATE. The central control portions of the distributed OSPF control protocols continue thereafter (310 and 311) as initiated by routers 12 and 14.

In the above example, the generation of OSPF HELLO messages may be off-loaded to the off-load portion of the distributed OSPF control protocol by several methods. For example, control-processor 32b may specify a message template, a frequency of message generation, and an outgoing interface to receive and send the message, to general-purpose processor 35b. Once specified, forwarding-plane 34b may generate the HELLO message at processor 35b until the control-plane 32b instructs otherwise. In other embodiments, an application specific integrated circuit may be used to generate the HELLO message.

Similarly, responding to the HELLO message may also be off-loaded to the off-load portion of the distributed OSPF control protocol. Together, the off-loading of the HELLO message generation and response reduces traffic across back-planes 36a and 36b and processing load on control planes 32a and 32b.

The HELLO protocols may be selected as an off-load portion of the distributed OSPF control protocol for several reasons. For example, OSPF control protocol requires the periodic exchange of HELLO messages to verify that links between routers 12 and 14 are operational and to elect a designated router and back up routers to route packets over network 10. As such, HELLO operations require significant and somewhat redundant overhead from a control processor implementing a traditional OSPF protocol. These types of control protocol operations are ideal for off-loading; especially for routers having hundreds of ports capable of receiving HELLO messages over a short duration, since the operations are relatively repetitive and the control-plane may watch over them with relatively little overhead.

Other OSPF protocols such as sending link state advertising requests (i.e., LSA requests) and rejecting erroneous LSA requests may also be off-loaded onto forwarding planes 34a and 34b for similar reasons. For example, the off-load portion of the distributed control protocol may include the filtering and dropping of flooded LSA requests when an identical LSA request has previously been received within a given time period (e.g., within one second of a prior LSA request). This may allow router 14 to send the link-state headers for each LSA stored in router 14 (e.g. in a database) to router 12 in a series of DATABASE DESCRIPTION packets from forwarding-plane 34b, as shown in FIG. 3. In such an example, one DATABASE DESCRIPTION packet may be outstanding at any time and router 14 may send the next DATABASE DESCRIPTION packet after the previous packet is acknowledged though receipt of a properly sequenced DATABASE DESCRIPTION packet from router 12.

In this example, the off-load control protocol may be implemented by keeping a copy of the link-state headers, which are also stored on the control planes 32a and 32b, on forwarding-plane 34b. These copies of the link-state headers enable their exchange to be completely off-loaded from the control-planes 32a and 32b to forwarding planes 34a and 34b. The control plane processor 33a may then only step in after all the link-state headers have been exchanged to receive (307) the complete data description or to update the copy of the link-state headers stored on the forwarding planes. This complete data description, here LSA information, may be used as needed by router 14.

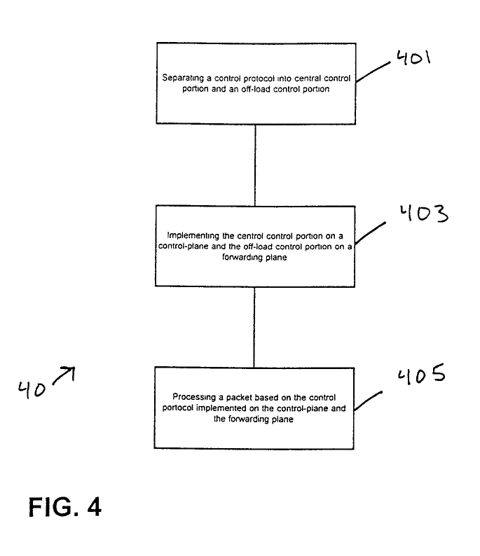

FIG. 4 shows process 40 for implementing a distributed control protocol on a router. Process 40 separates (401) a router control protocol (e.g., OSPF, RIP, LDP, or RSVP) into a central control protocol and an off-load portion. Process 40 separates (401) the router control protocol based upon, for example, which operations in the protocol are most efficiently performed by forwarding-planes 24a, 24b and 24c and which operations may be most efficiently performed on control-plane 22. Other factors in separating (401) may also be considered, such as the capability of the router to perform particular operations at the control-plane 22 and the forwarding-planes 24a, 24b and 24c. This separation (401) may also be completed prior to installation on a router 20 or at router 20 based on the particular resources of that router.

Process 40 implements (403) the central control portion of the distributed control protocol on a control-plane 22 and the off-load control portion on the forwarding planes 24a, 24b and/or 24c to process (405) a control packet according to the control protocol. In other words, process 40 may process a control packet without that packet knowing a distributed process is being implemented.

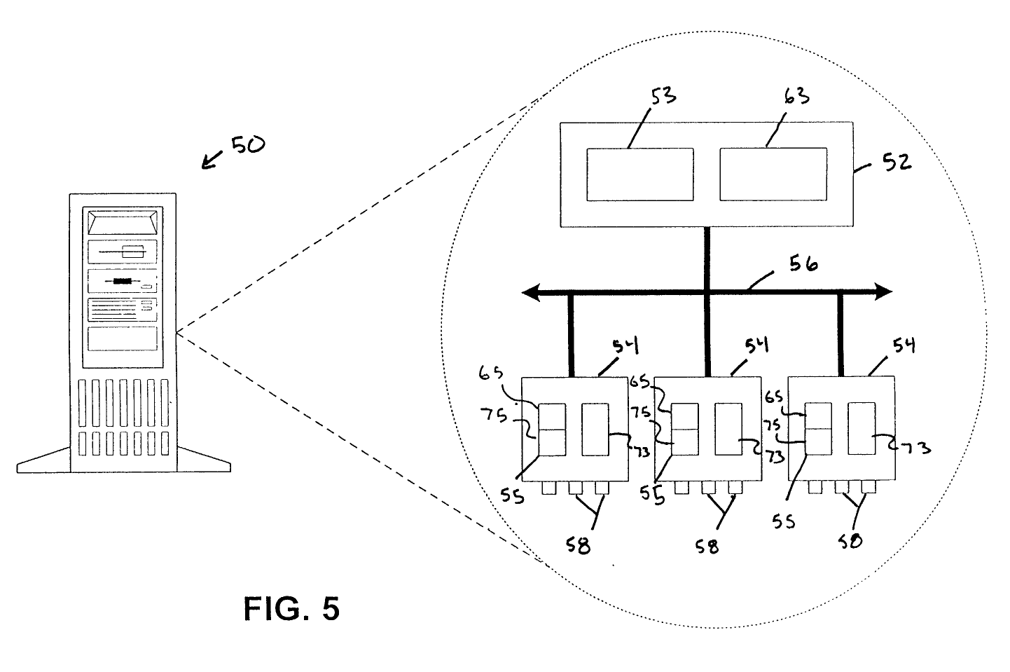

FIG. 5 shows a router 50 for implementing a distributed control protocol. Router 50 includes a control-plane 52, several forwarding-planes 54 and a back-plane 56.

Control-plane 52 includes a control processor 53 and a storage medium 63 (e.g., a hard disk). Processor 53 implements the central control portion of the distributed control protocol based on information stored in storage medium 63. Forwarding-plane 54 includes a forwarding processor 55, here a network processor combining a general purpose RISC processor 65 (e.g., a Reduced Instruction Set Computer) with a set of specialized packet processing engines 75, a storage medium 73, and a plurality of ports 58. Here, general purpose processor 65 performs the off-load portion of the distributed control protocol and the packet processing engines 75 perform packet forwarding and processing functions. Storage medium 73 (e.g., a 32 megabyte static random access memory and a 512 megabyte synchronous dynamic access memory) cache and store information necessary to complete the off-load portions of the distributed router control protocol. In other embodiments, an application specific integrated circuit may be used to implement a portion of the distributed control protocol.

The distributed control protocol may be implemented in computer programs executing on programmable computers or other machines that each includes a network processor and a storage medium readable by the processor.

Each such program may be implemented in a high level procedural or object-oriented programming language to communicate with a computer system. However, the programs can be implemented in assembly or machine language. The language may be a compiled or an interpreted language.

Each computer program may be stored on an article of manufacture, such as a CD-ROM, hard disk, or magnetic diskette, that is readable by router 50 to direct and control data packets in the manner described above. The distributed control protocol may also be implemented as a machine-readable storage medium, configured with one or more computer programs, where, upon execution, instructions in the computer program(s) cause the network processor to operate as described above.

A number of embodiments of the invention have been described. Nevertheless, it will be understood that various modifications may be made without departing from the spirit and scope of the invention. For example, other router control protocols may be separated into distributed router control protocols. In particular, the generation of PATH and RESV refresh messages in RSVP control protocol may be selected as an off-load portion. Here, the central control portion may provide state information (e.g., a copy of the refresh state received from a particular next or previous hop) so that the forwarding plane may process some of the incoming refresh messages. Also the HELLO processing of Label Distribution Protocol (“LDP”) and Constrained based LDP (“CD-LDP”) may be fully offloaded in a manner as explained above. The same distribution may also apply to Intra-Domain Intermediate System to Intermediate System Routing Protocol (“IS-IS”) by offloading its HELLO processing onto a forwarding-plane. Accordingly, other embodiments are within the scope of the following claims.

What is claimed is:

1. A router using a distributed implementation of a routing control protocol to route a packet between a plurality of computer networks, comprising:
a control-plane having a control-plane processor to implement a central control portion of the control protocol;
a plurality of forwarding-planes, each having a forwarding-plane processor to implement an offload control portion of the control protocol and a plurality of ports to connect the router to the computer networks; and
a back-plane to connect the control plane to the plurality of forwarding-planes and to enable processing of the packet based on an implementation of the control protocol by the control-plane and the forwarding-plane.

2. The router of claim 1, wherein the offload control portion of the control protocol generates an outgoing control message.

3. The router of claim 2, wherein the control protocol is OPEN SHORTEST PATH FIRST protocol and the outgoing control message is a HELLO message.

4. The router of claim 2, wherein the control protocol is RESOURCE RESERVATION protocol and the outgoing control message is a PATH message.

5. The router of claim 2, wherein the control protocol is INTRA-DOMAIN INTERMEDIATE SYSTEM TO INTERMEDIATE SYSTEM ROUTING PROTOCOL and the outgoing control message is a HELLO message.

6. The router of claim 1, wherein the offload control portion of the control protocol responds to an incoming request to the control protocol.

7. The router of claim 6, wherein the control protocol is OPEN SHORTEST PATH FIRST and the incoming request is a link status request.

8. The router of claim 6, wherein the control protocol is RESOURCE RESERVATION and the incoming request is a RESV request.

9. The router of claim 6, wherein the control protocol is INTRA-DOMAIN INTERMEDIATE SYSTEM TO INTERMEDIATE SYSTEM ROUTING PROTOCOL and the incoming request is a HELLO request.

10. The router of claim 1, wherein the control-plane and the forwarding-plane together implement a plurality of control protocols.

11. The router of claim 10, wherein the plurality of control protocols include OPEN SHORTEST PATH FIRST and RESOURCE RESERVATION.

12. The router of claim 1, wherein the plurality of ports include a plurality of virtual interfaces on a physical interface.

13. The router of claim 1, wherein the forwarding-plane processor includes:
a processing engine to implement a plurality of packet processing functions for routing the packet; and
a general purpose processor to implement the offload control portion of the control protocol.

14. The router of claim 1, wherein the off-load control portion of the control protocol operates to reduce a control flow load on the back-plane between the control-plane and the forwarding plane.

15. The router of claim 1, wherein the off-load control portion of the control protocol operates to reduce a processing load on the control-plane processor.

16. A method of processing a packet between two or more computer networks using a distributed implementation of a control protocol, comprising:
implementing a central control portion of a control protocol in a control-plane of a router and an offload control portion of the control protocol in a forwarding-plane of the router, the control-plane and forwarding plane being connected to each other by a back-plane; and
processing the packet based on an implementation of the control protocol by the control-plane and the forwarding-plane.

17. The method of claim 16, wherein the offload control portion of the control protocol generates an outgoing control message.

18. The method of claim 17, wherein the control protocol is OPEN SHORTEST PATH FIRST protocol and the outgoing control message is a HELLO message.

19. The method of claim 17, wherein the control protocol is RESOURCE RESERVATION protocol and the outgoing control message is a PATH message.

20. The method of claim 16, wherein the offload control portion of the control protocol responds to an incoming request to the control protocol.

21. The method of claim 20, wherein the control protocol is OPEN SHORTEST PATH FIRST and the incoming request is a LSA request.

22. The method of claim 20, wherein the control protocol is RESOURCE RESERVATION and the incoming request is a RESV request.

23. The method of claim 16, wherein the control-plane and the forwarding-plane implement a plurality of control protocols.

24. The method of claim 23, wherein the plurality of control protocols include OPEN SHORTEST PATH FIRST and RESOURCE RESERVATION.

25. The method of claim 16, further comprising, separating the control protocol into the central control portion and the off-load control portion to reduce a control flow load on the back-plane between the control-plane and the forwarding plane.

26. The method of claim 16, wherein the off-load control portion of the control protocol operates to reduce a processing load on the control-plane processor.

27. An article comprising a computer-readable medium that stores instructions for use by a router in processing a packet, the instructions for causing the router to:
implement a central control portion of a control protocol in a control-plane of the router and an offload control portion of the control protocol in a forwarding-plane of the router, the control-plane and forwarding plane being connected to each other by a back-plane; and
process the packet based on an implementation of the control protocol by the control-plane and the forwarding-plane.

28. The article in claim 27, wherein the offload control portion of the control protocol comprises instructions to control a generation of an outgoing control message.

29. The article in claim 27, wherein the offload control portion of the control protocol comprises instructions to control a response to an incoming request in the control protocol.

30. The article in claim 27, further comprising instructions to:
implement a plurality of packet processing functions at a processing engine in the forwarding-plane; and
implement the offload control portion of the control protocol at a general-purpose processor in the forwarding-plane.
